(19) United States
(12) Patent Application Publication
(10) Pub. No.: US 2023/0132712 A1
(43) Pub. Date: May 4, 2023

(54) CONSOLE TABLE

(71) Applicant: INTEVA PRODUCTS, LLC, Troy, MI (US)

(72) Inventors: Robert Piccard, Ray, MI (US); Aidano Nascimento, Oakland, MI (US); Tyler R. Bame, Clawson, MI (US)

(21) Appl. No.: 17/976,312

(22) Filed: Oct. 28, 2022

Related U.S. Application Data
(60) Provisional application No. 63/273,682, filed on Oct. 29, 2021.

(51) Int. Cl. B60N 3/00

(52) U.S. Cl. CPC B60N 3/002

(57) ABSTRACT

A console table for a vehicle interior, including: a pair of deployable tables each pivotally mounted to an exterior of a housing of the console table, the pair of deployable tables being capable of moving from a stowed position wherein the pair of deployable tables are adjacent to the exterior of the housing of the console table to a deployed position wherein the pair of deployable tables are deployed for use.

### CROSS REFERENCE TO RELATED APPLICATIONS

This application claims priority to U.S. Provisional Patent Application Ser. No. 63/273,682 filed on Oct. 29, 2021, the entire contents of which are incorporated herein by reference thereto.

### BACKGROUND

Exemplary embodiments of the present disclosure pertain to the art of vehicle interiors.

Some higher end vehicles have built in tables that fold out of the center console for the second or third row occupants. The method of storing the table inside the console reduces the storage space available for the occupants use. Having the tables inside the bin can also trap items inside, or the tables themselves can be blocked from removal until other items in the bin are removed, creating frustration for the user.

### BRIEF DESCRIPTION

Disclosed is a console table for a vehicle interior, including: a pair of deployable tables each pivotally mounted to an exterior of a housing of the console table, the pair of deployable tables being capable of moving from a stowed position wherein the pair of deployable tables are adjacent to the exterior of the housing of the console table to a deployed position wherein the pair of deployable tables are deployed for use.

In addition to one or more of the features described above, or as an alternative to any of the foregoing embodiments, the pair of deployable tables have one portion pivotally or rotationally mounted to the housing in order to allow for movement in a first direction and a direction opposite to the first direction and another portion that allows for the movement in a second direction and a direction opposite to the second direction.

In addition to one or more of the features described above, or as an alternative to any of the foregoing embodiments, the pair of deployable tables have a foam cushioning or decorative surface that comprises a portion of the exterior of the console table when the pair of deployable tables are in the stowed position.

In addition to one or more of the features described above, or as an alternative to any of the foregoing embodiments, the decorative surface of the pair of deployable tables matches a decorative surface of a top door of the console table.

In addition to one or more of the features described above, or as an alternative to any of the foregoing embodiments, the top door provides access to an interior compartment of the housing of the console table.

In addition to one or more of the features described above, or as an alternative to any of the foregoing embodiments, the pair of deployable tables have a foam cushioning that comprises a portion of the exterior of the console table when the pair of deployable tables are in the stowed position and wherein the foam cushioning faces downwardly when the pair of deployable tables are in the deployed position.

### BRIEF DESCRIPTION OF THE DRAWINGS

The following descriptions should not be considered limiting in any way. With reference to the accompanying drawings, like elements are numbered alike:

FIG. 1 is a perspective view of a console table showing of the present disclosure;

FIG. 2 is a front view of the console table of FIG. 1;

FIG. 3 is a rear view of the console table of FIG. 1;

FIG. 4 is a right side view of the console table of FIG. 1;

FIG. 5 is a left side view of the console table of FIG. 1;

FIG. 6 is a top view of the console table of FIG. 1;

FIG. 7 is a bottom view of the console table of FIG. 1;

FIG. 8 is a side view of the console table of FIG. 1 in a first orientation;

FIG. 9 is a rear view of the console table of FIG. 1 in the first orientation;

FIG. 10 is a top view of the console table of FIG. 1 in a second orientation;

FIG. 11 is a front view of the console table of FIG. 1 in the second orientation;

FIG. 12 is a bottom view of the console table of FIG. 1 in the second orientation;

FIG. 13 is a perspective view of the console table of FIG. 1 in a vehicle;

FIG. 14 is a perspective view of the console table of FIG. 1 in a vehicle in the first orientation;

FIG. 15 is a perspective view of the console table of FIG. 1 in a vehicle in the second orientation; and

FIG. 16 is a perspective view of the console table of FIG. 1 in a vehicle in a third orientation.

### DETAILED DESCRIPTION

A detailed description of one or more embodiments of the disclosed apparatus and method are presented herein by way of exemplification and not limitation with reference to the Figures.

The present disclosure moves the deployable table to the outside of the console, where it is then integrated into the side of the console. This gives the occupant the function of the table while maximizing the internal usable space of the console. Moving the table to the outside of the console increases the ease of use by allowing the user to visual see the table as it goes thru its deploying and stowing motions, and because items within the console do not need to be removed prior, creating a more enjoyable function. No more lost items bouncing around the tables in the bin. Having the table being external to the console also helps create an aesthetically pleasing feature for vehicle presentation and showcase the vehicle as it has a table for use without the dealer needing to specifically show it. This also opens up the possibilities for designer to add more styling features, touch surfaces, and bezel accessories on the side panel that doesn't usually get a lot of visual impact. The wrapped feature side on the console also becomes the bottom of the table so foam buns for soft touch can then be against the occupants legs, increasing the quality and feel of the table assembly.

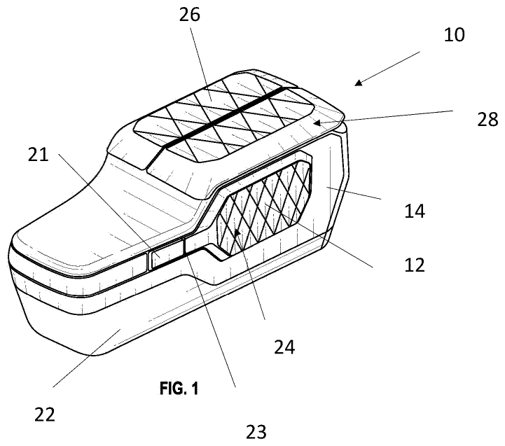

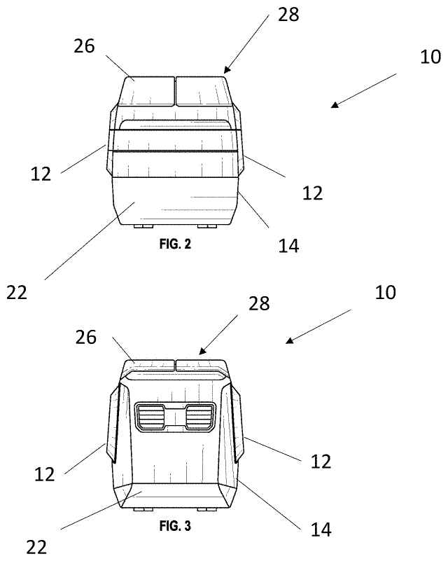

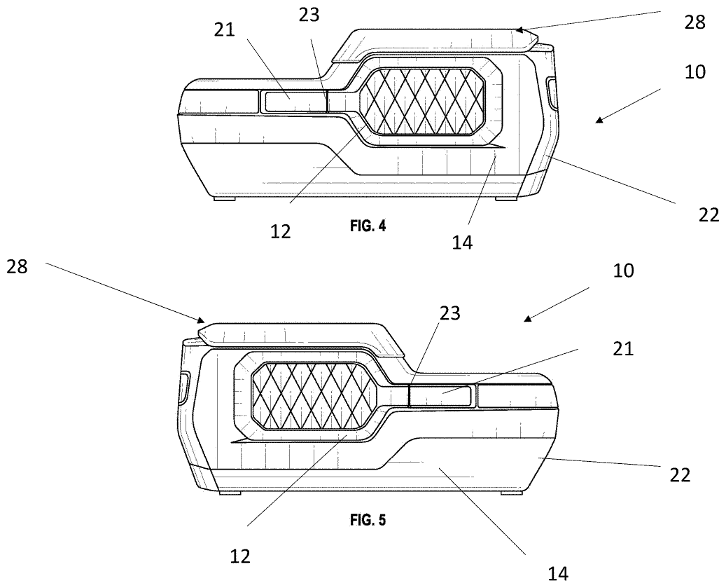

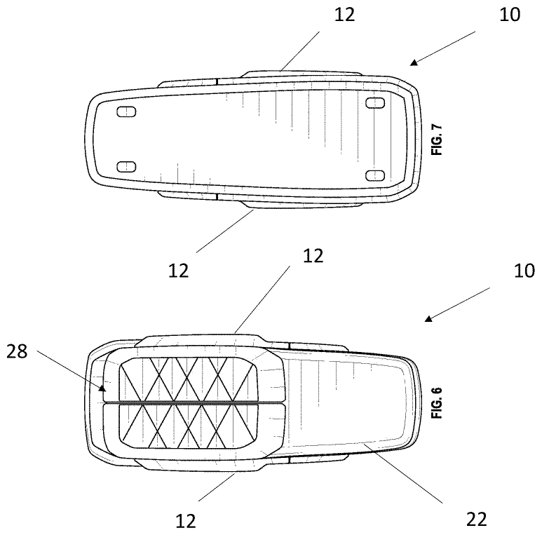

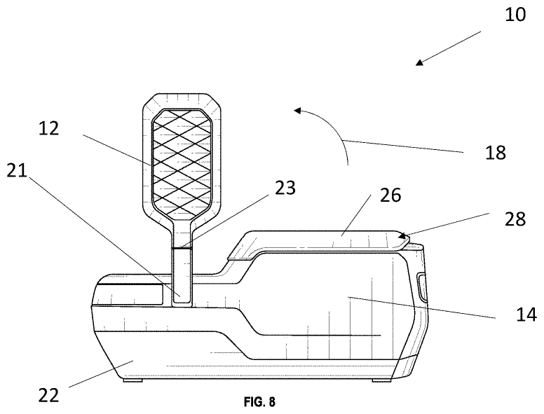

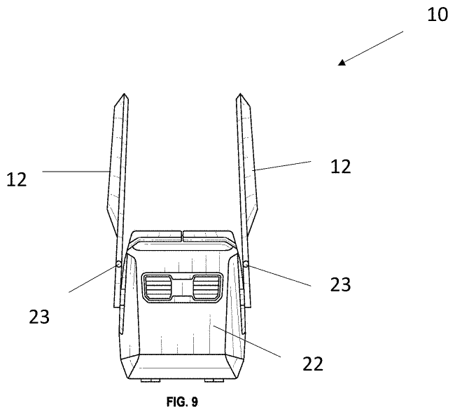

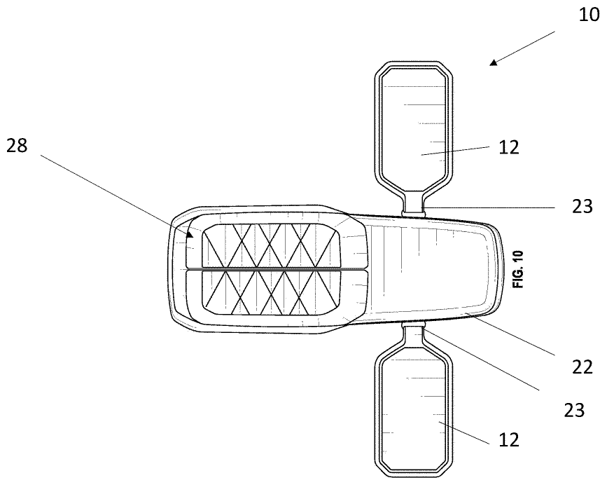

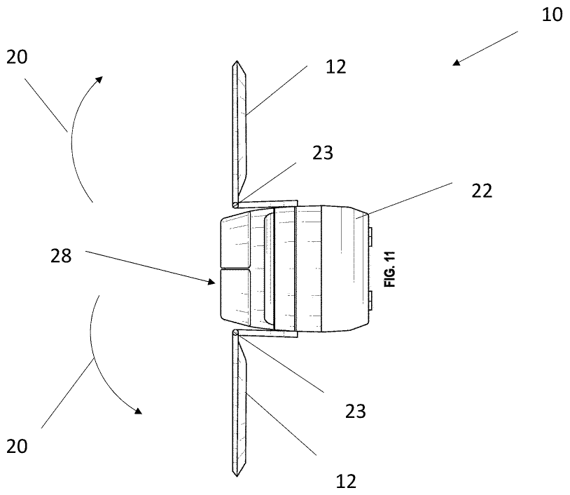

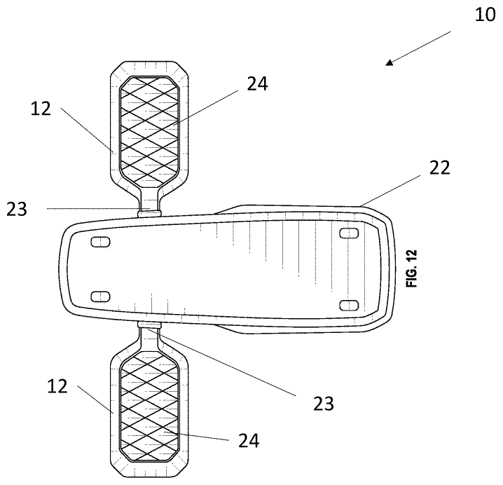

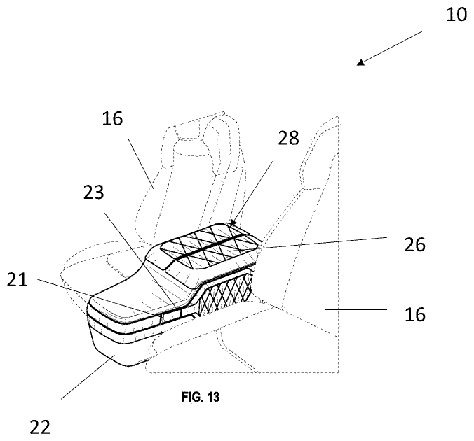

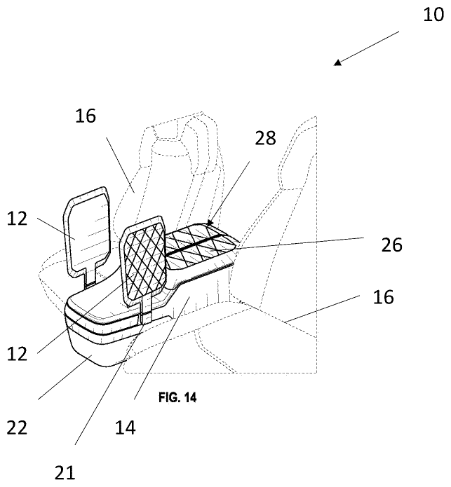

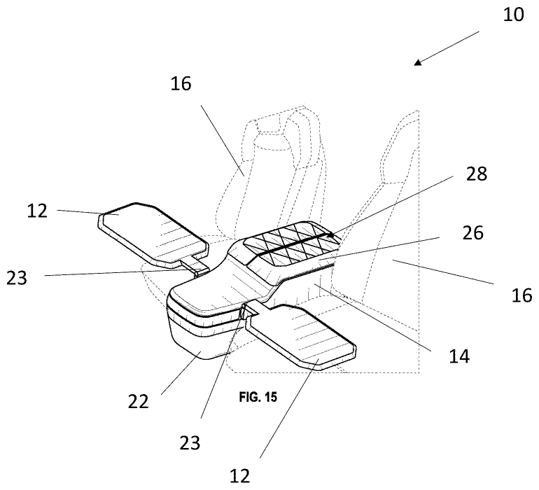

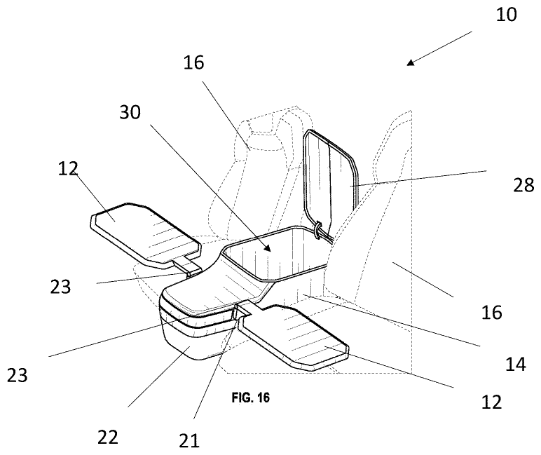

FIG. 1 is a perspective view of a console table 10 according to the present disclosure. FIG. 2 is a front view of the console table of FIG. 1. FIG. 3 is a rear view of the console table of FIG. 1. FIG. 4 is a right side view of the console table of FIG. 1. FIG. 5 is a left side view of the console table of FIG. 1. FIG. 6 is a top view of the console table of FIG. 1. FIG. 7 is a bottom view of the console table of FIG. 1. FIG. 8 is a side view of the console table of FIG. 1 in a first orientation. FIG. 9 is a rear view of the console table of FIG. 1 in the first orientation. FIG. 10 is a top view of the console table of FIG. 1 in a second orientation. FIG. 11 is a front view of the console table of FIG. 1 in the second orientation. FIG. 12 is a bottom view of the console table of FIG. 1 in the second orientation. FIG. 13 is a perspective view of the console table of FIG. 1 in a vehicle. FIG. 14 is a perspective view of the console table of FIG. 1 in a vehicle in the first orientation. FIG. 15 is a perspective view of the console table of FIG. 1 in a vehicle in the second orientation. FIG. 16 is a perspective view of the console table of FIG. 1 in a vehicle in a third orientation.

As illustrated in the attached FIGS. the console table 10 has a pair of deployable tables 12 each pivotally mounted to an exterior 14 of the console table 10. The pair of deployable tables 12 are capable of moving from a stowed position illustrated in at least FIGS. 1-7 and 13, where the pair of deployable tables 12 are adjacent to the exterior 14 of the console table 10 to a deployed position (see at least FIGS. 10, 12, 15 and 16) wherein the pair of deployable tables 12 are deployed for use by occupants sitting in seats 16 of a vehicle interior.

In order to deploy the pair of deployable tables 12 they are first rotated upwardly in the direction of arrow 18 to the position illustrated in at least FIGS. 8, 9 and 14 and then they are pivoted downwardly in the direction of arrows 20 to the position illustrated in at least FIGS. 10, 12, 15 and 16. Thereafter and in order to return the pair of deployable tables 12 to the stowed position an opposite movement is applied. The pair of deployable tables 12 are mounted to the exterior 14 of a housing 22 of the console table 10. In order to facilitate this movement, the pair of deployable tables 12 have one portion 21 pivotally or rotationally mounted to the housing 22 in order to allow for movement in the direction of arrow 18 and a direction opposite to arrow 18 and another portion 23 (e.g., a hinge or equivalent device) that allows for the movement in the direction of arrows 20 and a direction opposite to arrows 20.

As mentioned above and since the pair of deployable tables 12 are mounted to the exterior 14 of a housing 22 of the console table 10, the pair of deployable tables 12 can have a foam cushioning or decorative surface 24 that comprises a portion of the exterior of the console table 10 when the pair of deployable tables 12 are in the stowed position.

In one embodiment the decorative surface 24 of the pair of deployable tables 12 matches a decorative surface 26 of a top door 28 of the console table 10. The top door 28 provides access to an interior compartment 30 of the housing 22 of the console table 10 as illustrated in at least FIG. 16.

The decorative surface 24 may comprise a foam cushioning that when in the deployed position will be facing the legs of an occupant sitting in the seats 16.

As mentioned above and by mounting the pair of deployable tables 12 to the exterior 14 of the housing 22 of the console table 10 the compartment 30 is not blocked or filled with the pair of deployable tables 12.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A console table for a vehicle interior, comprising:
a pair of deployable tables each pivotally mounted to an exterior of a housing of the console table, the pair of deployable tables being capable of moving from a stowed position wherein the pair of deployable tables are adjacent to the exterior of the housing of the console table to a deployed position wherein the pair of deployable tables are deployed for use.

2. The console table as in claim 1, wherein the pair of deployable tables have one portion pivotally or rotationally mounted to the housing in order to allow for movement in a first direction and a direction opposite to the first direction and another portion that allows for the movement in a second direction and a direction opposite to the second direction.

3. The console table as in claim 1, wherein the pair of deployable tables have a foam cushioning or decorative surface that comprises a portion of the exterior of the console table when the pair of deployable tables are in the stowed position.

4. The console table as in claim 3, wherein the decorative surface of the pair of deployable tables matches a decorative surface of a top door of the console table.

5. The console table as in claim 4, wherein the top door provides access to an interior compartment of the housing of the console table.

6. The console table as in claim 1, wherein the pair of deployable tables have a foam cushioning that comprises a portion of the exterior of the console table when the pair of deployable tables are in the stowed position and wherein the foam cushioning faces downwardly when the pair of deployable tables are in the deployed position.

7. The console table as in claim 2, wherein the pair of deployable tables have a foam cushioning or decorative surface that comprises a portion of the exterior of the console table when the pair of deployable tables are in the stowed position.

8. The console table as in claim 7, wherein the decorative surface of the pair of deployable tables matches a decorative surface of a top door of the console table.

9. The console table as in claim 8, wherein the top door provides access to an interior compartment of the housing of the console table.

10. The console table as in claim 9, wherein the foam cushioning of the pair of deployable tables faces downwardly when the pair of deployable tables are in the deployed position.
